(19) United States
(12) Patent Application Publication
(10) Pub. No.: US 2006/0054198 A1
(43) Pub. Date: Mar. 16, 2006

(54) Dishwasher and control method thereof

(75) Inventor: Seung Bong Choi, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/059,305

(22) Filed: Feb. 17, 2005

(30) Foreign Application Priority Data
Sep. 16, 2004 (KR) P2004-74124

(51) Int. Cl. B08B 3/00

(52) U.S. Cl. 134/56 D; 134/58 D

(57) ABSTRACT

The present invention provides a dishwasher and a control method thereof, by which water of high pressure can be effectively supplied to spray nozzles with a small-sized motor having a small maximum output. The present invention includes a tub receiving tableware therein, a plurality of spray arms situated at different heights arms within the tub, respectively, the spray arms including upper and lower arms spraying water on the tableware, and a sump assembly including a sump housing storing the water therein, a pump coupled with the sump housing to pump the water, and a diverting valve alternately guiding the pumped water to the upper and lower arms. The present invention includes the steps of operating a pump motor at a predetermined RPM, alternately supplying pumped water to spray arms arranged at different heights within a tub, respectively, deciding whether the water is supplied to the spray arm arranged at a higher position, and operating the motor at an RPM higher than the predetermined RPM if the water is supplied to the spray arm arranged at the higher position.

This application claims the benefit of the Korean Application No. P2004-74124 filed on Sep. 16, 2004, which is hereby incorporated by reference.

### BACKGROUND OF THE INVENTION

1. Field of the Invention

The present invention relates to a dishwasher, and more particularly, to a dishwasher and a control method thereof, by which water is stored in the sump assembly to be supplied to spray nozzles and by which the water stored in the sump assembly is controllable to be supplied to the spray nozzles.

2. Discussion of the Related Art

Generally, a dishwasher is a home appliance for washing tableware by spraying water of high pressure on the tableware using spray nozzles. A general dishwasher consists of a tub having a washing chamber inside, a plurality of dish racks provided within the tub, a plurality of spray nozzles spraying water on the dish racks, and a sump assembly storing the water therein and supplying the water to the spray nozzles.

In operating the dishwasher, clean water supplied from outside is stored in the sump assembly and the sump assembly supplies the water stored inside to the spray nozzles. The spray nozzles then spray the water on dishes put on the dish racks within the tub to wash them.

Meanwhile, if a volume of the dishwasher is great, several racks differing in height are arranged within the dishwasher and several spray nozzles are arranged in different heights within the dishwasher to spray water to the racks, respectively. And, the sump assembly simultaneously supplies the water of high pressure to the respective spray nozzles.

However, a motor driving a pump needs a maximum output and large size of a motor to supply the water of high pressure to the several spray nozzles arranged in the different heights. Hence, the dishwasher of the great volume should employ an expensive pump. And, sizes of the pump and case increase as well.

### SUMMARY OF THE INVENTION

Accordingly, the present invention is directed to a dishwasher and a control method thereof that substantially obviate one or more problems due to limitations and disadvantages of the related art.

An object of the present invention is to provide a dishwasher and a control method thereof, by which water of high pressure can be effectively supplied to spray nozzles with a small-sized motor having a small maximum output.

Another object of the present invention is to provide a dishwasher and a control method thereof, by which water of high pressure can be supplied to spray nozzles arranged in high positions.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dishwasher according to the present invention includes a tub receiving tableware therein, a plurality of spray arms situated at different heights arms within the tub, respectively, the spray arms including upper and lower arms spraying water on the tableware, and a sump assembly including a sump housing storing the water therein, a pump coupled with the sump housing to pump the water, and a diverting valve alternately guiding the pumped water to the upper and lower arms.

Preferably, the pump is configured to supply the water having a pressure higher than that of the water supplied to the lower arm to the upper arm. And, the pump can be configured to supply the water having a pressure proportional to an installation height of each of the spray arms to each of the spray arms.

Preferably, the pump includes a motor configured to be driven at a first RPM higher than a second RPM when the diverting valve guides the water to the upper arm wherein the second RPM is used when the diverting valve guides the water to the lower arm. And, the pump may include a motor configured to be driven at an RPM proportional to an installation height of the spray arm to which the water is supplied.

Preferably, the diverting valve includes a space communicating with passages connected to the spray arms to allow the pumped water to pass and a rib selectively blocking the passages when the diverting valve is rotated. And, the diverting valve includes a pair of plates arranged to leave a prescribed distance from each other, a space provided between the plates, the space communicating with passages connected to the spray arms to allow the pumped water to pass, and a rib provided between the plates to selectively block the passages when the diverting valve is rotated.

Preferably, the sump assembly further includes a passage guide provided within the sump housing to have guide passages supplying the water guided by the diverting valve to the spray arms. And, the diverting valve can be situated within the passage guide.

More preferably, the pump includes an impeller situated within the passage guide to be rotated to pump the water. And, the impeller can be configured to rotate at a rotational speed proportional to a height of the corresponding spray arm supplied with the water.

More preferably, the passage guide includes an upper housing provided within the sump housing to have the guide passage and a lower housing coupled with the upper housing to have a soil chamber into which a portion of the pumped water is introduced.

More preferably, the sump assembly further includes a filter provided over the soil chamber to filter the water flooding over the soil chamber. And, the sump assembly may further includes a cover having at least one aperture guiding the water falling from the tub and the water having passed through the filter to the sump housing to cover the sump housing.

In another aspect of the present invention, a method of controlling a dishwasher includes the steps of pumping water and alternately supplying the water to spray arms arranged at different heights within a tub, respectively.

Preferably, the method further includes the step of supplying the pumped water having a pressure higher than that of the water supplied to the spray arm at a lower height to the spray arm at a higher spray arm.

Preferably, the method further includes the step of supplying the pumped water having a pressure proportional to an installation height of each of the spray arms to the corresponding spray arm.

In another aspect of the present invention, a method of controlling a dishwasher includes the steps of driving a motor of a pump pumping water and alternately supplying the water to spray arms arranged at different heights within a tub, respectively by switching a diverting valve.

Preferably, the method further includes the step of when the diverting valve supplies the pumped water to the spray arm arranged at a higher position, driving the motor at an RPM higher than that is used in supplying the water to the spray arm arranged at a lower position.

Preferably, the method further includes the step of driving the motor at an RPM proportional to an installation height of the spray arm supplied with the water.

In a further aspect of the present invention, a method of controlling a dishwasher includes the steps of operating a pump motor at a predetermined RPM, alternately supplying pumped water to spray arms arranged at different heights within a tub, respectively, deciding whether the water is supplied to the spray arm arranged at a higher position, and operating the motor at an RPM higher than the predetermined RPM if the water is supplied to the spray arm arranged at the higher position.

Preferably, the pumped water supplying step includes the step of intermittently switching a diverting valve provided to a diverging point of guide passages connecting the pump to the spray arms, respectively.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional diagram of a dishwasher according to the present invention;

FIG. 2 is an exploded diagram of a sump assembly according to the present invention;

FIG. 3A is a layout of a diverting valve in the sump assembly of FIG. 2, in which the diverting valve guides water to a first passage communicating with a lower arm;

FIG. 3B is a layout of a diverting valve in the sump assembly of FIG. 2, in which the diverting valve guides water to a second passage communicating with an upper arm;

FIG. 3C is a layout of a diverting valve in the sump assembly of FIG. 2, in which the diverting valve simultaneously guides water to first and second passages; and

FIG. 5 is a flowchart of a control method of a sump assembly of a dishwasher according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

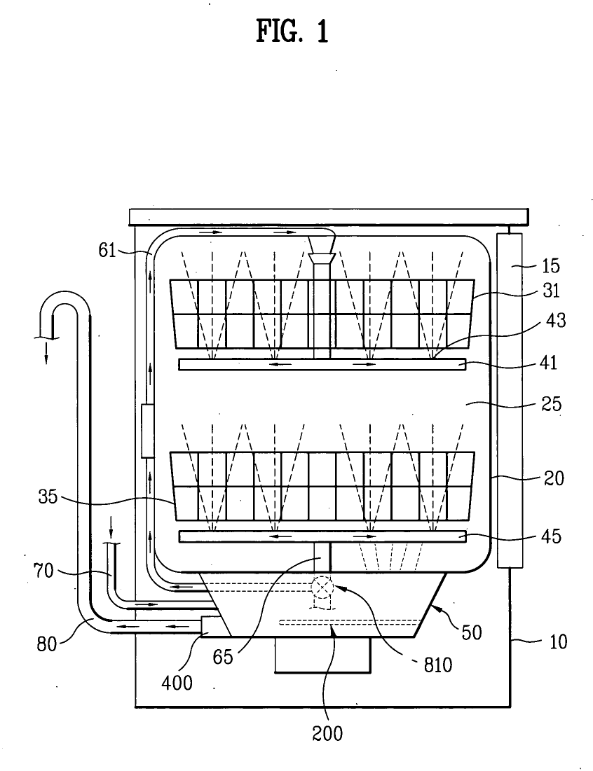

FIG. 1 is a cross-sectional diagram of a dishwasher according to the present invention.

Referring to FIG. 1, a tub 20 is provided within a case 10 forming an exterior of a dishwasher, and a door 15 opening/closing the tub 20 is provided to one side of the case 10. A washing chamber 25 for accommodating tableware or dishes therein is provided within the tub 20. And, at least one rack is provided to the washing chamber 25 so that the dishes can be put thereon. For instance, the rack, as shown in FIG. 1, includes an upper rack 31 provided to an upper part of the washing chamber 25 and a lower rack 35 provided to a lower part of the washing chamber 25.

Moreover, at least one spray arm is provided in the vicinity of the rack within the washing chamber 25. For instance, the spray arm, as shown in FIG. 1, includes an upper arm 41 arranged under the upper rack 31 and a lower arm 45 arranged under the lower rack 35. The upper and lower arms 41 and 45 are respectively rotatable, and each of the upper and lower arms 41 and 45 includes at least one spray nozzle 43 spraying water toward the dishes.

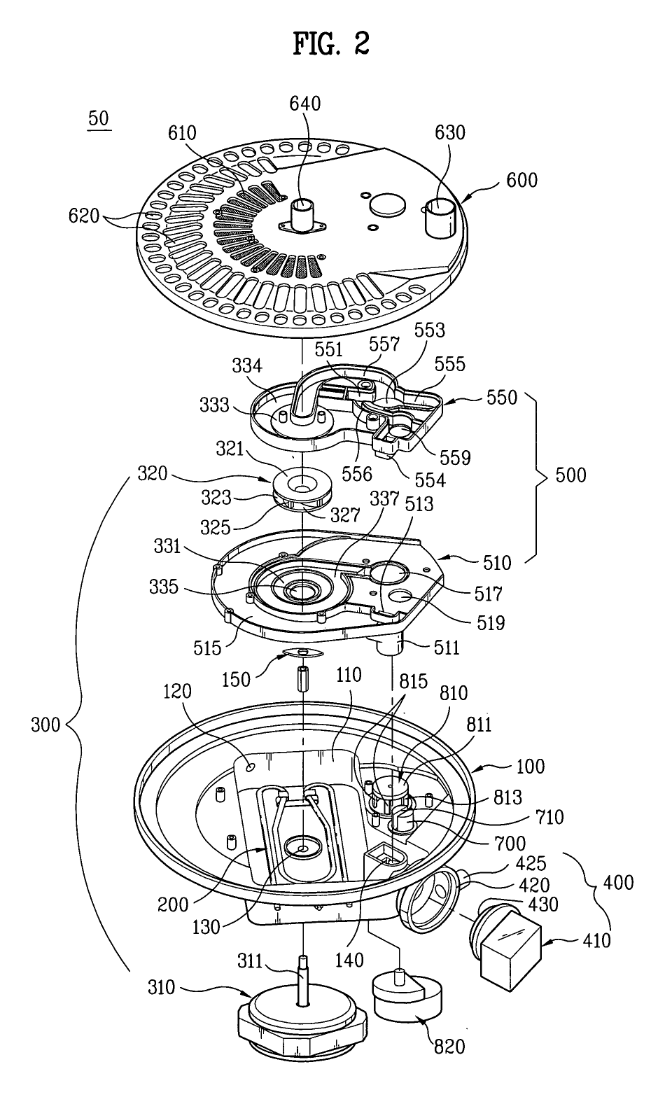

A sump assembly 50 supplying water to the upper and lower arms 41 and 45 is provided within the case 10, e.g., under the tub 20. The sump assembly 50 is connected to the upper arm 41 via a first connecting pipe 61 and is connected to the lower arm 45 via a second connecting pipe 65 as well. And, the sump assembly 50 is supplied with the water from outside via a water supply pipe 70 to store the supplied water therein and selectively or simultaneously supply the water to the upper and lower arms 41 and 45 via the first and second connecting pipes 61 and 65, respectively. A detailed configuration of the sump assembly 50 is shown in FIG. 2, and the sump assembly 50 is explained in detail with reference to FIG. 2 as follows.

Referring to FIG. 2, the sump assembly 50 includes a sump housing 100 storing water therein, a heater assembly 200 for heating the water, a drain pump 400 for draining the water outside, a water supply pump 300 for pumping the water stored in the sump housing 100, a water guide 500 for supplying the pumped water to the upper and lower arms 41 and 45, and a cover 600 covering the sump housing 100 to filter the water.

A recess 110 is provided to a bottom center of the sump housing 100 to store the water, and a water supply hole 120 is provided to one side of the recess 100 to be connected to the water supply pipe 70. And, a drain chamber 140 is provided to the sump housing 100 in the vicinity of the recess 110. The drain chamber 140 includes a hole (not shown in the drawing) provided to a lateral side of the drain chamber 140 to communicate with the recess 110 and an open top communicating with a soil chamber 515 provided to the water guide 500.

The drain pump 400 is loaded in a lateral side of the sump housing 100. The drain pump 400 communicates with the drain chamber 140 and discharges the water within the recess 110, the drain chamber 140, and the soil chamber 515 outside. And, the drain pump 400 includes an impeller housing 420, a motor 410, and an impeller 430.

The impeller housing 420, as shown in FIG. 2, is coupled with a lateral side of the sump housing 100 and communicates with the drain chamber 140. Optionally, the impeller housing 420 can be built in one body of the sump housing 100. A nipple 425 is projected from a lateral side of the impeller housing 420 to be connected to a drain hose 80.

The motor 410 having a shaft, with which the impeller 430 is coupled, is assembled to the impeller housing 420 so that the impeller 430 can be inserted in the impeller housing 420. Hence, once the drain pump 400 is actuated, the water stored in the recess 110, the drain chamber 140, and the soil chamber 515 is discharged outside via the drain chamber 140, the drain pump 400, and the drain hose 80.

Meanwhile, the dishwasher according to the present invention can completely remove the adhesive food attached to the dishes using hot water. For this, the heater assembly 200 is provided within the sump housing 100 to heat the water stored in the recess 110. The heater assembly 200 is detachably provided to the sump housing 100 so as to be externally detached from the sump housing 100.

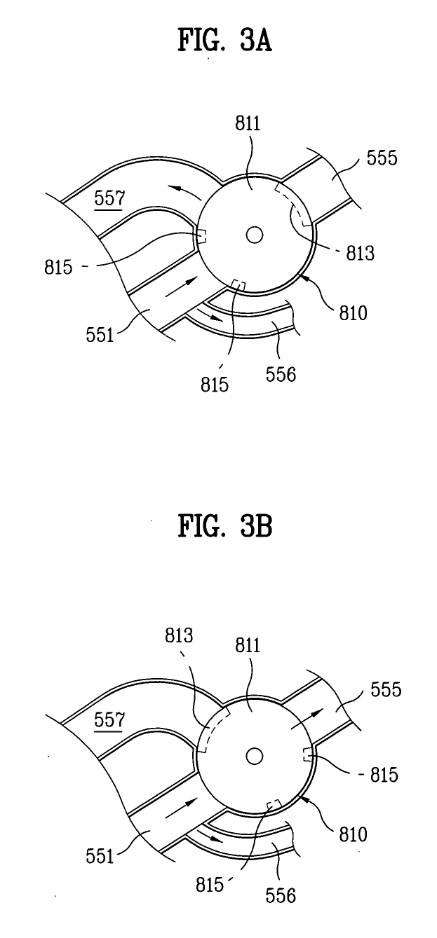

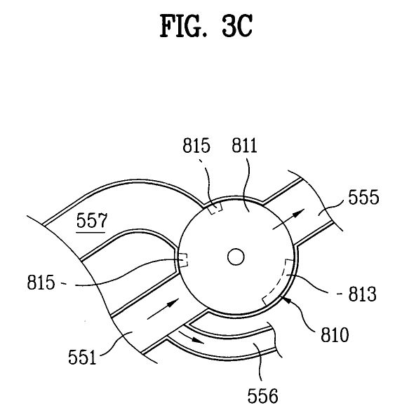

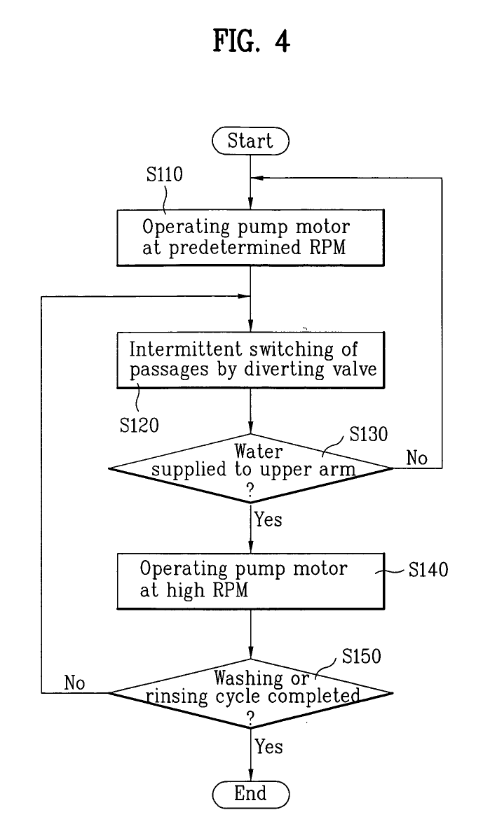

The heater assembly 200 is situated at a bottom of the sump housing, e.g., a bottom of the recess 110. An opening 160, as shown in FIG. 3, is provided to a lateral side of the sump housing 100, and the heater assembly 200 is installed to penetrate the opening 160.

One end of the heater 210 is fixed to the sump housing 100 by the fixing mechanism, whereas the other end 210 of the heater 210 is held and supported by a clamp 290 provided to the bottom of the sump housing 100. The clamp 290 is fixed to the bottom of the recess 110 and holds the heat generating unit 211 to prevent the heat generating unit 211 from being fluctuated by a flow of the water.

The water supply pump 300 pumps the water over the heater assembly 200 to supply the water heated by the heater assembly 200 to the spray arms without heat loss. The water supply pump 300 includes a motor 310, an impeller 320, and an impeller housing, which is explained in detail as follows.

First of all, the motor 310, as shown in FIG. 2, is installed at a bottom of the sump housing 100. A shaft 311 of the motor 310 is installed to penetrate a hole 130 provided to a bottom of the recess 110. A disposer 150 having a multitude of blades, as shown in FIG. 2, is assembled to the shaft 311 penetrating the bottom of the sump housing 100. If the motor 310 is actuated, the disposer 150 is rotated to dispose or grind garbage that is contained in the water stored in the recess 110.

The impeller 320 is assembled to the shaft 311 as well. The impeller 320, as shown in FIG. 2, is situated over the heater assembly 200 and is rotated to pump the water heated by the heater assembly 200. The impeller 320 is explained in detail as follows.

First of all, the impeller 320 sucks the water in an axial direction and discharges the water in a radial direction. For this, the impeller 320 includes an upper plate 321, a lower plate separated from the upper plate 323 to leave a predetermined gap in-between, and a multitude of blades 325 provided between the upper and lower plates 321 and 323.

The upper plate 321 is blocked and an inlet (not shown in the drawing) is provided to a center of the lower plate 323 to have the water flow therein. A hub (not shown in the drawing) is provided to a center of the upper plate 321 and the shaft 311 is fitted in a lower end of the hub. A multitude of curved blades 325 are provided between the upper and lower plates 321 and 323, and an outlet 327 is provided between the blades 325 to discharge the water having flown in the impeller 320 via the inlet.

The impeller housing encloses the impeller 320 to guide the water moved by the impeller 320. The impeller housing is preferably built in one body of the water guide 500 instead of being formed of an independent body. In this case, the water guide 500 includes a lower housing 510 and an upper housing 550. If the upper and lower housings 550 are assembled, a portion of the assembly configures the impeller housing. The impeller housing is explained in detail as follows.

First of all, to a top surface of the lower housing 510 of the water guide 500, as shown in FIG. 2, provided are an inlet 335 via which the water stored in the recess 110 of the sump housing 100 flows, a lower recessed seat 331 accommodating a lower part of the impeller 320 therein, and a lower water passage 337 guiding the water pumped by the impeller 337. The lower recessed seat 331 is provided to enclose the inlet 335, and the inlet 335 communicates with the inlet (not shown in the drawing) of the impeller 320 situated on the lower recessed seat 331. And, the lower water passage 337 is provided to enclose the lower recessed seat 331.

To a bottom surface of the upper housing 550 of the water guide 500 provided are an upper recessed seat 333 accommodating an upper part of the impeller 320 to confront the lower recessed seat 331, an upper water passage 334 guiding the water pumped by the impeller 320 to confront the lower water passage 337, and an outlet 551 guiding the water pumped from the upper water passage 334 to an upper surface of the upper housing 550. The upper water passage 334 is provided to enclose the upper recessed seat 333 and the output 551 is formed at an end of the upper water passage 334.

Once the motor 310 is actuated, the impeller 320 is rotated in a space defined by the lower and upper recessed seats 331 and 333. The water stored in the recess 110 of the sump housing 100 flows in the impeller 320 via the inlet 335 and the impeller 320 discharges the water in a radial direction. The water discharged from the impeller 320 moves along the water passage defined by the lower and upper water passages 337 and 334 and is finally led to the top surface of the upper housing 550 of the water guide 500 via the outlet 551. A portion of the water having flown to the top surface of the upper housing 550 is alternately guided to the upper or lower arm 41 or 45 or is simultaneously guided to the upper and lower arms 41 and 45. The water guide 500 is explained in detail as follows.

First of all, the water guide 500 includes the upper and lower housings 550 and 510. The upper housing 550 is provided with a valve receiving portion 553 communicating with the outlet 551. And, first and second guide passages 557 and 555 for supplying the water to the lower and upper arms 45 and 41 are connected to the valve receiving portion 553, respectively. In this case, the first guide passage 557 is provided to the top surface of the upper housing 550 from the valve receiving portion 553 to a center of the upper housing 550, while the second guide passage 555 is provided to the top surface of the upper housing 550 from the valve receiving portion 553 to an edge of the upper housing 550.

A diverting valve 810 is situated at the valve receiving portion 553 to guide a portion of the water flowing from the outlet 551 to the first or second guide passages 557 or 555 selectively or to the first and second guide passages 557 and 555 simultaneously. The diverting valve 810, as shown in FIG. 2, includes a pair of circular plates 811 and ribs 813 and 815 provided between the circular plates 811.

A space, through which the water passes, is provided between a pair of the circular plates 811. And, the ribs 813 and 815 are arranged on a circumference of the diverting valve 810 to leave a prescribed distance from each other. The space communicates with the passages communicating with the spray arms, i.e., the first and second guide passages 557 and 555, and the rib 813 alternately blocks the first and second guide passages 557 and 555 when the diverting valve 810 revolves. For this, the rib 813, as shown in FIGS. 3A to 3C, has a width that is great enough to selectively block the first or second guide passage 557 or 555. And, each of the two ribs 815 has a width that is small enough not to interrupt a flow of the water. Moreover, a pair of the ribs 815 support a pair of the circular plates 811.

The diverting valve 810, as shown in FIG. 2, is loaded in the sump housing 100 and becomes situated at the valve receiving portion 553 when the water guide 500 is assembled to the sump housing 100. For this, a hole 517 is formed at the lower housing 510 to correspond to the valve receiving portion 553 and to be penetrated by the diverting valve 810.

A driving mechanism for actuating the diverting valve 810 is provided under the sump housing 100. The driving mechanism, as shown in FIG. 2, includes a power source e.g., a motor 810, connected to the diverting valve 810. Hence, when the dishwasher washes or rinses the dishes, the diverting valve 810 is reversibly rotated by the driving mechanism intermittently. In doing so, the rib 813, as shown in FIG. 3A and FIG. 3B, alternately blocks the first and second guide passage 557 or 555.

Hence, the water, as shown in FIG. 3A and FIG. 3B, pumped by the water supply pump 300 is alternately supplied to the first and second guide passages 557 and 555. The water led to the first and second guide passages 557 and 555 is supplied to the upper and lower arms 45 and 41, respectively.

Thus, if the supply passage of the water is intermittently switched, the pumped water is supplied to one of the several spray arms only. Hence, the pressure of the water supplied to the corresponding spray arm is raised, whereby a pump having a motor of a small maximum output can provide a sufficient supply pressure of the water.

Meanwhile, since the upper arm 41 is arranged at a position higher than that of the lower arm 45, the pressure of the water sprayed from the upper arm 41 is lower than that of the water sprayed from the lower arm 45 even if the water supply pump 300 pumps the water at the same pressure. Hence, when the diverting valve 810 supplies the pumped water to the spray arms arranged at the higher position, i.e., the upper arm 41, it is necessary to compensate the pressure reduction of the water attributed to height.

For this, the water supply pump 300 supplies the water having a pressure higher than that of the water supplied to the lower arm 45 to the upper arm 41. For instance, when the diverting valve 810 guides the water to the upper arm 41, the motor 310 of the water supply pump 300 is operated at an RPM higher than that is used in guiding the water to the lower arm 45, whereby the water of high pressure can be supplied to the upper arm 41.

Furthermore, if several spray arms are arranged within the tub 20 to differ in height, the water supply pump 300 supplies the water to each of the spray arms at a pressure proportional to each installation height of the respective spray arms. For instance, the motor 310 is operated at the RPM proportional to the installation height of the spray arm to which the water is supplied, whereby each of the spray arms can be supplied with the water of the pressure proportional to the height of the corresponding spray arm.

Meanwhile, the rib 813, as shown in FIG. 3C, may not block any of the first and second guide passages 557 and 555. In such a case, the water, which was pumped to be introduced into the diverting valve 810, is supplied to both of the first and second guide passages 557 and 555. Hence, the pumped water is supplied to the entire spray arms. In this case, even if the pressure of the water supplied to each of the spray arms is lowered more or less, the water can be effectively used in a cycle needing no high pressure such as a rinsing cycle.

Meanwhile, after having been pumped by the water supply pump 300, the rest of the water guided to the top surface of the upper housing 550 is used in measuring a degree of pollution of the water, is filtered, and then goes back to the sump housing 100 to be stored in the recess 110, which is explained in detail as follows.

First of all, a bypass 556 communicating with the outlet 551 is provided to the top surface of the upper housing 550. A sensor receiving portion 559 is provided in the middle of the bypass 556. A sensor assembly 700 is situated in the sensor receiving portion 559 to measure a degree of pollution of the water that is introduced into the bypass 556 by being pumped by the water supply pump 300.

The sensor assembly 700, as shown in FIG. 2, is loaded in the sump housing 100 to be situated at the sensor receiving portion 559 when the water guide 500 is loaded on the sump housing 100. For this, a hole 519 is provided to the lower housing 510 to correspond to the sensor receiving portion 559 and to be penetrated by the sensor assembly 700.

A channel 710 communicating with the bypass 556, as shown in FIG. 2, is provided to traverse a center of the sensor assembly 700. Hence, the water introduced into the bypass 556 passes through the channel 710. A light emitting unit (not shown in the drawing) and a light receiving unit (not shown in the drawing) are provided within the sensor assembly 700 to oppose each other by leaving the channel 710 in-between. A light emitted from the light emitting unit is passed through the water flowing in the channel 710 to arrive at the light receiving unit. Hence, the sensor assembly 700 measures the degree of pollution of the water based on the intensity of the light received by the light receiving unit.

The water pollution degree measured by the sensor assembly 700 is used as a basis for determining a washing time, a washing number, a rinsing time, a rinsing number, and the like. For instance, if a quantity of light arriving at the light receiving unit is very weak, it means that the water is badly polluted. In such a case, the dishwasher changes the water or extends the washing or rinsing number by at least one time.

Meanwhile, the water having passed through the sensor assembly 700 arrives at a first drain 554 provided to an end of the bypass 556. The first drain 554 is connected to a second drain 513 provided to the lower housing 510, and extends to the drain chamber 140 of the sump housing 100 from the lower housing 510. Hence, the rest of the water, which is introduced into the top surface of the upper housing 550 after having been pumped by the water supply pump 300, is passed through the bypass 556, the sensor assembly 700, and the first and second drains 554 and 513 to be introduced into the drain chamber 140.

The water in the drain chamber 140 is not discharged outside via the drain hose 80 unless the drain pump is actuated 400. As a check valve (not shown in the drawing) opening/closing the hole (not shown in the drawing), via which the drain chamber 140 and the recess 110 communicate with each other, is provided to the drain chamber 140, the water in the drain chamber 140 is not introduced into the recess 110 as well.

Hence, the water introduced into the drain chamber 140 ascends along a third drain 511 via which the drain chamber 140 and the soil chamber 515 of the lower housing 510 to flow in the soil chamber 515. In ding so, heavy garbage included in the water introduced into the drain chamber 140 is deposited at a bottom of the drain chamber 140 due to its weight but the light garbage and water are introduced into the soil chamber 515. Hence, the drain chamber 140 makes the garbage deposited to be operative in filtering the water.

The soil chamber 515, as shown in FIG. 2, is provided to the lower housing 510 to enclose the impeller housing of the water supply pump 300. The soil chamber 515 receives to store the water passed through the bypass 556 and the drain chamber 140 after the water have been pumped by the water supply pump 300. If the water keeps flowing in the soil chamber 515, a water level of the soil chamber 515 rises and the water finally floods out of the soil chamber 515.

Meanwhile, the cover 600 covers the water guide 500 and the sump housing 100. For instance, the cover 600 has a disc shape. A multitude of openings are provided to its central part. And, a mesh type filter 610, as shown in FIG. 2, is provided to each of the openings. In this case, the openings and the filters 610 are arranged over the soil chamber 515. Hence, the water flooding from the soil chamber 515 passes through the filter 610 to be filtered and the dirt or garbage failing to pass through the filter 610 remains in the soil chamber 515.

A multitude of apertures 620 are provided to an edge area of the cover 600. The apertures 620 guide the falling water used in washing the dishes in the tub 20 of the dishwasher and the flooding water passed through the filter 610 from the soil chamber 515 to the sump housing 100. The water guided to the sump housing 100 is stored in the recess 110 at the center of the sump housing 100 together.

A first nipple 640 at a center of the cover 600 and a second nipple 630 at an edge of the cover 600, as shown in FIG. 2, are provided to a top surface of the cover 600. The first nipple 640 communicates with the first guide passage 557 of the water guide 500 and the second nipple communicates with the second guide passages 555 of the water guide 500. The second connecting pipe 65 connected to the lower arm 45 is connected to the first nipple 640, and the first connecting pipe 61 connected to the upper arm 41 is connected to the second nipple 630. Hence, the water introduced into the first guide passage 557 is supplied to the lower arm 45 via the first nipple 640 and the second connecting pipe 65. And, the water introduced into the second guide passage 555 is supplied to the lower arm 45 via the second nipple 630 and the first connecting pipe 61.

An operational process of the above-configured sump assembly according to the present invention is explained as follows.

First of all, if the dishwasher initiates a process of washing or rinsing dishes, clean water is introduced into the recess 110 of the sump housing 100 via the water supply hole 120 connected to the water supply pipe 70. The water introduced into the recess 110 is then heated by the heater 210.

If a corresponding water supply is completed, the motor 310 of the water supply pump 300 is driven so that the impeller 320 pumps the water stored in the recess 110. In doing so, the motor 310 is operated at a predetermined RPM (S110), whereby the impeller 320 is rotated according to the predetermined RPM to pump the water.

The diverting valve 810 intermittently revolves so that the rib 813 alternately blocks the first and second guide passages 557 and 555 to switch the passages via which the water flows (S120). Hence, the water, which was pumped by the water supply pump 300 to be introduced into the space of the diverting valve 810, is alternately introduced into the first and second guide passages 557 and 555.

The water led to the first guide passage 557 is supplied to the lower arm 45, while the other water led to the second guide passage 555 is supplied to the upper arm 41. The water supplied to the lower arm 45 washes the dishes put on the lower rack 35 and the water supplied the upper arm 41 washes the dishes put on the upper rack 31.

Meanwhile, a control unit of the dishwasher decides whether the water is being supplied to the upper arm 41 by a guidance of the diverting valve 810 (S130). If the water is not being supplied to the upper arm 41, i.e., if the water is being supplied to the lower arm 45, the control unit keeps driving the motor 310 at the predetermined RPM.

On the other hand, if the water is being supplied to the upper arm 41, the control unit drives the motor 310 at an RPM higher than the predetermined RPM (S140). If so, the impeller 320 rotates at high rotational speed to pump the water at high pressure to supply the water of high pressure to the upper arm 41.

Subsequently, the control unit decides whether the washing or rinsing cycle of dishes is completed (S150). If the washing or rinsing cycle is not completed, e.g., if a predetermined time fails to pass, the dishwasher, as shown in FIG. 4, repeats the above steps to wash or rinse the dishes put on the upper and lower racks 31 and 35 alternately. In doing so, the water supply pump 300 supplies the water of relatively high pressure to the upper arm 41 and the water of relatively low pressure to the lower arm 45. Thus, the pressure of the water sprayed on each of the upper and lower arms 41 and 45 is kept uniform not to leave a difference in-between.

The water used in washing the dishes in the tub 20 and the garbage or soil detached from the dishes fall down to the bottom of the tub 20. The falling garbage and water are re-introduced into the sump housing 100 via the apertures 620 provided to a circumference of the cover 600 to be re-stored in the recess 110.

As mentioned in the foregoing description, the water fed back to the sump housing 110 contains a considerable amount of dirt or garbage. The garbage is finely grinded by the disposer 150 situated between the impeller 320 and the bottom of the recess 110 of the sump housing 100. And, the finely grinded garbage is pumped by the pump together with the water.

Meanwhile, the rest of the water pumped by the impeller 320 of the pump is introduced into the bypass 556. The water introduced into the bypass 556 passes through the channel 710 of the sensor assembly 700 that accurately measures the pollution degree of the water flowing in the channel 710. Hence, the dishwasher automatically adjusts the washing time, the washing number, the rinsing time, the rinsing number, etc. based on the pollution degree of the water sensed by the sensor assembly 700.

The water having passed through the channel 710 of the sensor assembly 700 is introduced into the drain chamber 140 via the first and second drains 554 and 513. In doing so, since the drain pump 400 is not working, the water in the drain chamber 140 is not discharged outside but is flown in the soil chamber 515 via the third drain 511. In ding so, heavy garbage included in the water introduced into the drain chamber 140 is deposited at a bottom of the drain chamber 140 due to its weight but the light garbage ascends along the third drain 511 to be introduced into the soil chamber 515.

The garbage and water introduced into the soil chamber 515 are stored therein. As time passes, the water level of the soil chamber 515 rises and the water finally floods out of the soil chamber 515. The flooding water is passed through the filters 610 and the apertures 620 of the sump housing 100 in turn to be re-introduced into the sump housing 100. Yet, the garbage introduced into the soil chamber 515 fails to pass through the filters 610 to be accumulated within the soil chamber 515.

As mentioned in the foregoing description, a prescribed quantity of the pumped water is passed through the bypass 556 to be purified by the filter 610 and is then re-supplied to the sump housing 100. In doing so, it may seem that the soil chamber 515 and the filter 610 are operative in filtering a small quantity of the water only. Yet, since they filter the water across the washing and rinsing cycles overall, excellent water-filtering performance is achieved.

Meanwhile, if the washing or rinsing cycle is completed or if the water is badly polluted, the drain pump 400 is actuated. If so, the water and garbage stored in the soil chamber 515, the drain chamber 140, and the recess 110 of the sump housing 100 are discharged outside by the drain pump 400 via the drain hose 80.

Accordingly, the sump assembly according to the present invention supplies alternately the water to the upper and lower arms. Hence, even if a motor having a small maximum output and a small size is employed, it is able to supply the water of high pressure to each of the spray arms. Therefore, it is able to increase a volume or capacity of the dishwasher without enlarging a size of the case.

And, the motor is rotated at the relatively high rotational speed in supplying the water to the upper arm or at the relatively low rotational speed in supplying the water to the lower arm. Therefore, the water is supplied to the upper arm with high pressure without pressure reduction, whereby washing or rinsing performance can be enhanced.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A dishwasher, comprising:
a tub receiving tableware therein;
a plurality of spray arms situated at different heights arms within the tub, respectively, the spray arms including upper and lower arms spraying water on the tableware; and
a sump assembly comprising:
a sump housing storing the water therein;
a pump coupled with the sump housing to pump the water; and
a diverting valve alternately guiding the pumped water to the upper
and lower arms.

2. The dishwasher of claim 1, wherein the pump is configured to supply the water having a pressure higher than that of the water supplied to the lower arm to the upper arm.

3. The dishwasher of claim 1, wherein the pump is configured to supply the water having a pressure proportional to an installation height of each of the spray arms to each of the spray arms.

4. The dishwasher of claim 1, the pump comprising a motor configured to be driven at a first RPM higher than a second RPM when the diverting valve guides the water to the upper arm wherein the second RPM is used when the diverting valve guides the water to the lower arm.

5. The dishwasher of claim 1, wherein the pump comprises a motor configured to be driven at an RPM proportional to an installation height of the spray arm to which the water is supplied.

6. The dishwasher of claim 1, the diverting valve comprising:
a space communicating with passages connected to the spray arms to allow the pumped water to pass; and
a rib selectively blocking the passages when the diverting valve is rotated.

7. The dishwasher of claim 1, the diverting valve comprising:
a pair of plates arranged to leave a prescribed distance from each other;
a space provided between the plates, the space communicating with passages connected to the spray arms to allow the pumped water to pass; and
a rib provided between the plates to selectively block the passages when the diverting valve is rotated.

8. The dishwasher of claim 1, wherein the sump assembly further comprises a passage guide provided within the sump housing to have guide passages supplying the water guided by the diverting valve to the spray arms.

9. The dishwasher of claim 8, wherein the diverting valve is situated within the passage guide.

10. The dishwasher of claim 8, wherein the pump comprises an impeller situated within the passage guide to be rotated to pump the water.

11. The dishwasher of claim 10, wherein the impeller is configured to rotate at a rotational speed proportional to a height of the corresponding spray arm supplied with the water.

12. The dishwasher of claim 8, the passage guide comprising:
an upper housing provided within the sump housing to have the guide passage; and
a lower housing coupled with the upper housing to have a soil chamber into which a portion of the pumped water is introduced.

13. The dishwasher of claim 12, the sump assembly further comprising a filter provided over the soil chamber to filter the water flooding over the soil chamber.

14. The dishwasher of claim 13, the sump assembly further comprising a cover having at least one aperture guiding the water falling from the tub and the water having passed through the filter to the sump housing to cover the sump housing.

15. A method of controlling a dishwasher, comprising the steps of:
pumping water; and
alternately supplying the water to spray arms arranged at different heights. within a tub, respectively.

16. The method of claim 15, further comprising the step of supplying the pumped water having a pressure higher than that of the water supplied to the spray arm at a lower height to the spray arm at a higher spray arm.

17. The method of claim 15, further comprising the step of supplying the pumped water having a pressure proportional to an installation height of each of the spray arms to the corresponding spray arm.

18. A method of controlling a dishwasher, comprising the steps of:
driving a motor of a pump pumping water; and
alternately supplying the water to spray arms arranged at different heights within a tub, respectively by switching a diverting valve.

19. The method of claim 18, further comprising the step of when the diverting valve supplies the pumped water to the spray arm arranged at a higher position, driving the motor at an RPM higher than that is used in supplying the water to the spray arm arranged at a lower position.

20. The method of claim 18, further comprising the step of driving the motor at an RPM proportional to an installation height of the spray arm supplied with the water.

21. A method of controlling a dishwasher, comprising the steps of:
operating a pump motor at a predetermined RPM;
alternately supplying pumped water to spray arms arranged at different heights within a tub, respectively;
deciding whether the water is supplied to the spray arm arranged at a higher position; and
operating the motor at an RPM higher than the predetermined RPM if the water is supplied to the spray arm arranged at the higher position.

22. The method of claim 21, the pumped water supplying step comprising the step of intermittently switching a diverting valve provided to a diverging point of guide passages connecting the pump to the spray arms, respectively.
